(19) United States
(12) Patent Application Publication
(10) Pub. No.: US 2011/0137982 A1
(43) Pub. Date: Jun. 9, 2011

(54) Business Infrastructure System and Method for Using Same

(75) Inventor: Douglas Colvin, Houston, TX (US)

(73) Assignee: Colvin Industries, Houston, TX (US)

(21) Appl. No.: 12/938,476

(22) Filed: Nov. 3, 2010

Related U.S. Application Data
(60) Provisional application No. 61/280,408, filed on Nov. 3, 2009.

(51) Int. Cl. G06F 15/16

(52) U.S. Cl. 709/203

(57) ABSTRACT

A system and method for consolidating a business infrastructure is provided. The business infrastructure may have an infrastructure unit for use in an office. The infrastructure unit may have a plurality of technology components. The plurality of technology components may have a telephone component configured to communicate with one or more phone cords located at the building and a server component for serving one or more client computers. The infrastructure unit may have a housing for containing the plurality of technology components and wherein the housing is movable within the office.

### CROSS-REFERENCE TO RELATED APPLICATIONS

This application claims the priority benefit of U.S. provisional patent application No. 61/280,408, titled “A BUSINESS TECHNOLOGY HUB CREATION PROCESS: A PROCESS, SYSTEM, AND METHOD FOR MANUFACTURING A CUSTOM AGGREGATED AND INTEGRATED TECHNOLOGY UNIT APPROPRIATE FOR TURNKEY DEPLOYMENT OF BUSINESS TECHNOLOGY INFRASTRUCTURE TO A SMALL OFFICE SITE,” filed Nov. 3, 2009. This related application is hereby incorporated by reference in its entirety.

### BACKGROUND

The invention relates to techniques for facilitating control of a business or residential infrastructure. More particularly, the invention relates to techniques for optimizing the business or residential infrastructure, for example, by providing multiple infrastructure systems in a consolidated infrastructure system.

When setting up a business or residence several infrastructure systems must be installed for the business or residence to operate properly. Typically the business will need infrastructure systems such as a phone system, an internet system, a server, and the like. Typically each of these infrastructure systems will have a dedicated location in the office or residence. For example, the server may have a server room and the telephone system may have a dedicated location in the office or residence. The owner or operator of the business may have to call several providers to come out and individually set up and install each of the infrastructure systems.

Despite the existence of techniques for installing separate infrastructure systems at an office or residence, there remains a need to provide a streamlined system for installing infrastructure systems. Such techniques are preferably capable of one or more of the following, among others: reducing design time, reducing procurement time, reducing installation time, minimizing space needed for infrastructure systems, reducing costs, and providing a reliable troubleshooting analysis on multiple infrastructure systems.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 is a schematic diagram depicting a consolidated infrastructure system for use at an office.

FIG. 2 is a schematic view of an infrastructure unit of the consolidated infrastructure system of FIG. 1.

FIG. 3 is a schematic view of the infrastructure unit according to one embodiment.

FIG. 4 is a flow diagram depicting the ordering and use of the consolidated infrastructure system.

### DESCRIPTION OF EMBODIMENT(S)

The description that follows comprises exemplary apparatus, methods, techniques, and instruction sequences that embody techniques of the inventive subject matter. However, it is understood that the described embodiments may be practiced without these specific details.

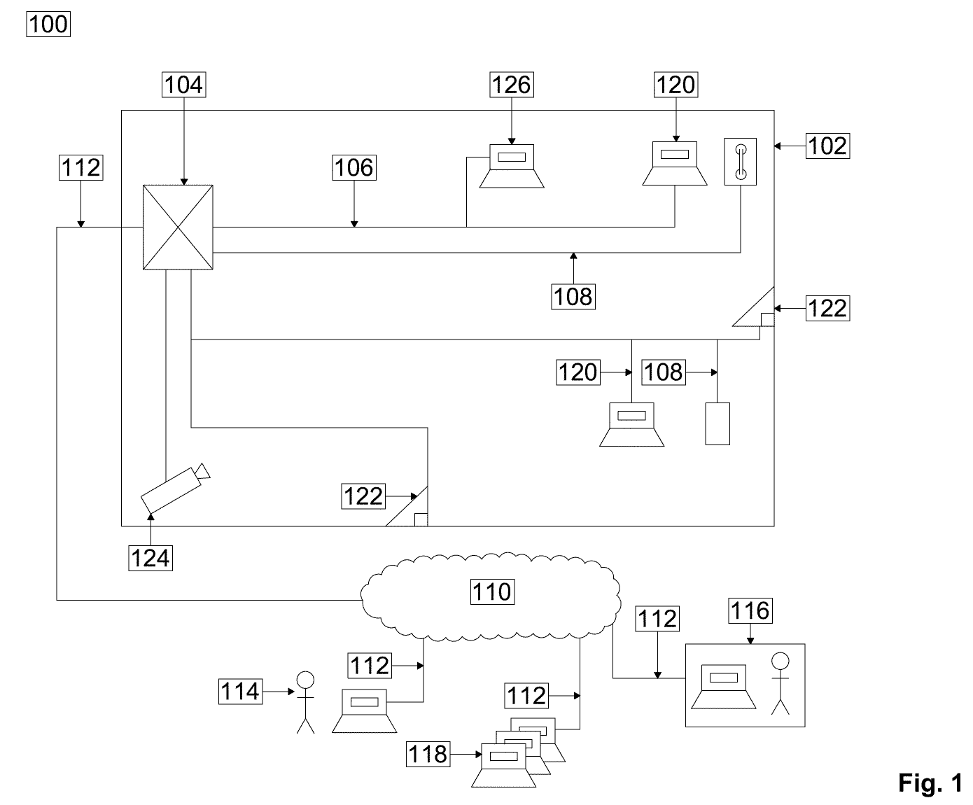

FIG. 1 shows a schematic diagram depicting a consolidated infrastructure system 100 for an office 102. The consolidated infrastructure system 100 may have an infrastructure unit 104. The infrastructure unit 104 may have one or more technology components located within a housing, as will be discussed in more detail below. The technology components may be configured to control and/or facilitate the use of one or more infrastructure systems 106 in the office 102. The infrastructure systems 106 may be any suitable system within the office 102 such as a telephone system 108. The infrastructure unit 104 may have all of the technology components needed to run, facilitate and/or manage the infrastructure systems 106 in the office 102.

The infrastructure unit 104 may couple to any number of communication systems 110 to facilitate use of the infrastructure systems 106. The communication systems 110 may be a computer network, a phone network, a satellite system, a cellular phone system, a Wi-Fi network, a wireless sensor network, a cable service network, a local area network (LAN), a personal area network (PAN), or a wide area network (WAN), or the connection may be made to an external computer (for example, through the Internet using an Internet Service Provider), and the like. The infrastructure unit 104 may communicate with the network via one or more communication links 112. The communication links 112 may be any suitable means for transmitting data, or power such as cables, wireless communication devices, electrical, optical, acoustical or other form of propagated signal (e.g., carrier waves, infrared signals, digital signals, etc.), or wireline, wireless, or other communications medium, and the like. The communication system 110 may allow office personnel 114 to order and customize the infrastructure unit 104, a technical support facility 116 to trouble shoot the infrastructure unit 104 and/or one or more clients 118 to communicate with the office 102, as will be discussed in more detail below. The office personnel 114, the technical support facility 116, and/or the clients 118 may communicate with the communication system 110 via the communication links 112.

The infrastructure systems 106 managed and/or facilitated by the infrastructure unit 104 may be any suitable infrastructure systems for use in the office 102. As shown in FIG. 1, the infrastructure systems 106 may include the telephone system 108, a computer system 120, a security system 122, a closed circuit television system 124, and/or an audio system 126. Further, the infrastructure systems 106 may include any suitable infrastructure systems such as a smoke detection system, a gas detection system, an alert system, an emergency response system, indoor lighting systems, outdoor lighting systems, air conditioning controls, HVAC systems, lighting systems, mechanical systems, water systems, multimedia systems, shade systems, data equipment systems (for example, printers, scanners, fax machines, external drives, virtual reality systems, and the like), structured cabling systems, sprinkler system controllers, distributed audio-video communication systems, paging systems, public address systems, mass notification systems, sound masking systems, intercommunication systems, program systems, assistive listening systems, healthcare communication and/or monitoring systems, patient monitoring systems, telemetry systems, telemedicine systems, healthcare imaging systems, nurse call systems, code blue systems, clock systems, infrared systems, radio frequency tracking systems, internal cellular systems, antenna systems, data communication systems (for example for desktop computers, laptops, handhelds, and the like), disaster recovery systems, voice communication systems, voice communication switching and routing systems, PBX systems, key systems, internet protocol voice switches, voice terminal equipment, point of sale systems, transportation information display systems, public information systems, any of the infrastructure systems described herein and the like.

The telephone system 108 may have any suitable devices and/or systems for supporting the telephone needs of the office 102. For example, the telephone systems 108 may have but is not limited to telephone sets, wireless transceivers, elevator telephones, ring-down emergency telephones, facsimiles, modems, TTY equipment, radio communication equipment, voice mail equipment, auto attendant equipment, interactive voice response, facsimile servers, and the like.

The audio system 126, or audio visual systems 126, may have any suitable systems and devices for supporting the office 102. For example, the audio system 126 may have, but is not limited to, architecturally integrated audio-video equipment, integrated audio video systems and equipment, portable audio-video equipment, audio-video accessories, master antenna television systems, audio-video conferencing, speaker systems, and the like.

The office 102 may be any suitable place of work. For example, the office 102 may be a large office building, a small office building, an office complex, a warehouse, a mechanic shop, a retail center, a restaurant, a bar, a stadium, a entertainment venue, an outdoor facility (such as an oil rig, oil platform, a construction site, and the like), a school, a dormitory, a hospital, a clinic, a doctors office, and the like. Although, the infrastructure unit 104 is shown as being used in a place of work, it should be appreciated that the infrastructure system may be used in a residential environment such as a house, a townhouse, an apartment complex and the like.

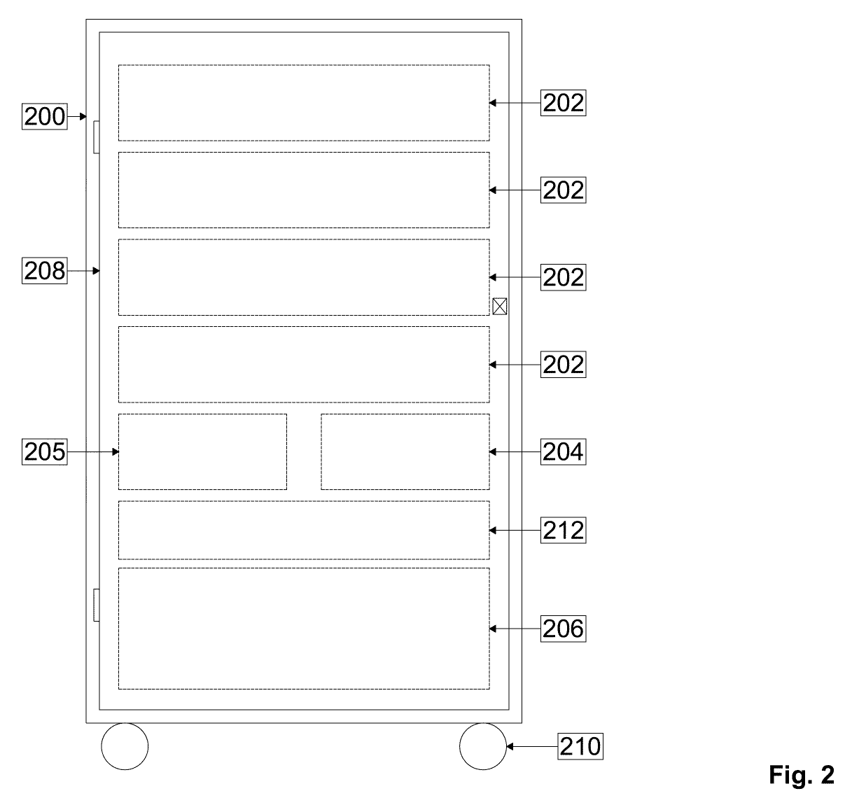

FIG. 2 depicts a schematic diagram of the infrastructure unit 104 of FIG. 1. The infrastructure unit 104 may have a housing 200 for protecting one or more technology components 202 located within the housing. Further, the infrastructure unit 104 may have a technical support unit 204, a controller 205, a cooling unit 206, a door 208, and/or one or more wheels 210. The wheels 210 may be any suitable wheel, caster, or rolling device to facilitate easy transport of the infrastructure unit 104. The door 210 may allow a person to access the interior of the infrastructure unit 104.

The housing 200, as shown, is an elongated cube shaped housing for securing the technology components with the infrastructure unit 104. The housing 200 may be specifically sized depending on the amount of technology components to be secured within the housing 200. Although, the housing 200 is shown as an elongated cube, it should be appreciated that the housing 200 may be any suitable shape for housing the contents of the infrastructure unit 104 such as a cube, a cylinder and the like. The housing 200 may include shelving, brackets, mounting rails, racks, shelves, bolts, screws, clamps, adhesives, ties, and the like to secure the technology components 202, the technical support unit 204, the controller 205 and/or the cooling unit 206 in the housing 200.

The housing 200 may be made of any suitable material such as metal, wood, plastic, ceramic and the like. Further, the housing 200 may be designed for specific environments. For example, the housing may be blast proof, fire proof, fire retardant, water proof, water resistant and the like.

The technology components 202 of the infrastructure unit 104 may be any components that suit the needs of the office 102. For example, the technology components 202 may include, but are not limited to, any combination of the following: a telephone component, a server component, a data backup component, a router system component (or data transmission component), a security system component (or controlled access component), an audio component, a visual component (television component), a closed circuit television component, an office equipment management component, a HVAC component, emergency alert component, an uninterrupted power supply component, a healthcare component, and the like. Any combination of the technology components 202 may be installed in the housing 200 of the infrastructure unit 104, as will be discussed in more detail below.

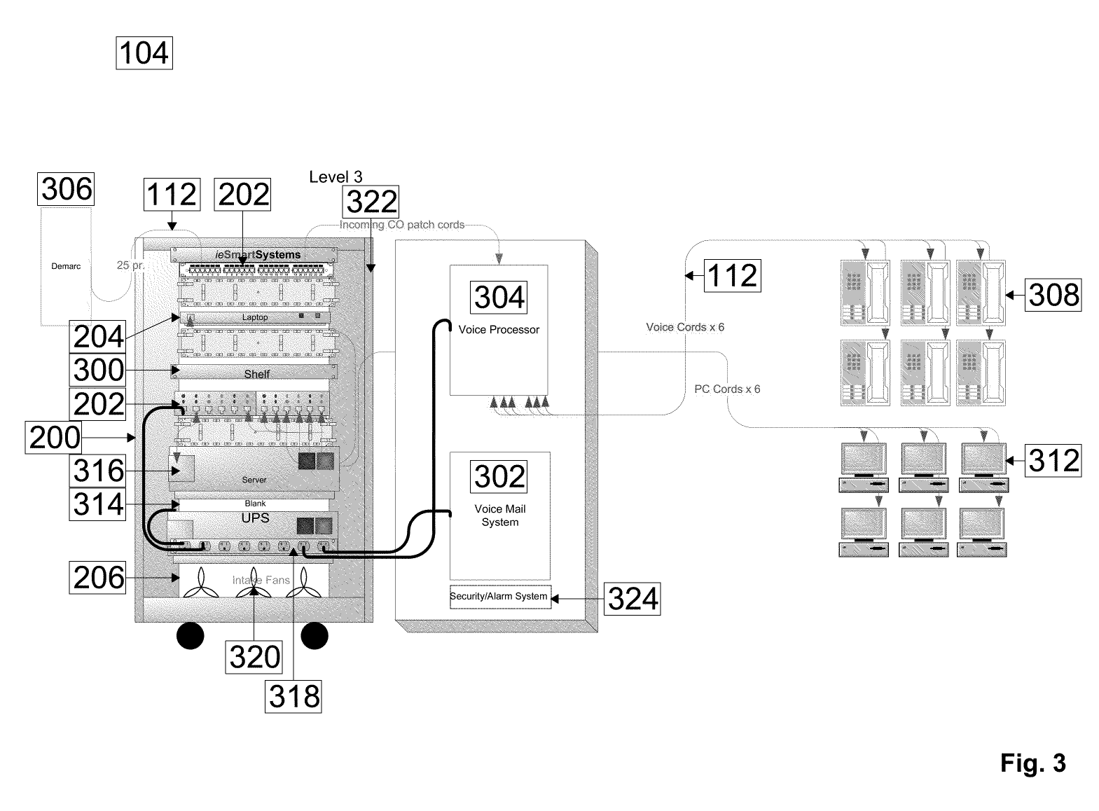

FIG. 3 depicts a schematic view of the infrastructure unit 104 having the telephone component as one or the technology components 202. The telephone component or components may include, but is not limited to, a telephone router 300, a voice mail system 302, and/or a voice processor 304. The telephone router 300 may be configured to couple to an outside telephone source 306 (or demarc) via a communication link 112. The telephone router 300 may be configured to service any number of telephones 308, depending on the office's need. The telephone router 300 may be any suitable router. The cords (or communication links 112) for the telephones 308 may be routed to the infrastructure unit 104 and hooked into the telephone router 300 and/or the voice processor 304. Therefore, once the infrastructure unit 104 is installed at the office 102 (as shown in FIG. 1), only the communication links 112 from the outside telephone source 306 and the telephones 308 need to be connected into the telephone component 300.

The infrastructure unit 104 may further have the router system component 310 as one of the technology components 202. The router system component 310 may be any suitable system for receiving and transmitting computer data (for example analog or digital data) about the office 102. The router component 310 may couple to the outside telephone system 306 or other outside communication system. The outside communication system may include, but are not limited to a broadband connection, a cable connection, a fiber optical connection and the like. The router system component 310 may then couple directly, or through an intermediate component to the one or more office computers 312. The router system component 310 may allow the office computers 312 to transmit data between the office computers and/or the communication systems 110 located outside of the office 102. The router system component 310 may be any suitable server and/or router system to suit the needs of the client. The router system component 310 may include, but is not limited to, data communications network equipment, data communication firewalls, data communication routers, CSU/DSU, multiplexers, Codecs, modems, data communication management components, data communications switches and/or hubs, data communication wireless access points, wireless transceivers, and the like. The cords (or communication links 112) for the office computers 312 may be routed to the infrastructure unit 104 and hooked into the router system component 310 and/or the voice processor 304. Therefore, once the infrastructure unit 104 is installed at the office 102 (as shown in FIG. 1), only the communication links 112 from the outside communication system and the office computers 312 need to be connected into the router system component 310. It should be appreciated that the computer cords and/or the telephone cords (or communication links) may be combined and routed to the infrastructure unit together.

The infrastructure unit 104 may further have a data backup component 314 (or storage component) as one of the technology components 202. The data backup component 314 may be any suitable component for storing data used, sent and/or received by the office 102. The data backup component 314 may have a machine readable medium for storing the data, or information. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. The data backup component 314 may communicatively couple to the router system component 310 and/or the office computers 312 in order to store and utilize information. There may be multiple data backup components 314 in order provide data protection in the event one of the data backup components 314 is damaged.

The infrastructure unit 104 may further have the server component 316 as one of the technology components 202. The server component may be any suitable server, or data communication server(s), for supporting the needs of the office 102 including, but not limited to, integrated automation network servers, integrated automation network routers, bridges, switches, hubs, modems, integrated automation network operator workstations, hardwired integration network gateways, direct protocol integration network gateways, neutral protocol integration network gateways, client server information/database integration network, gateways, data communication components (for example for desktops, laptops, and/or handheld devices), and the like. The server component 316 may be in communication with the router component 310 and/or the data backup component 314 via any of the cords or communication links 312.

The server component 316, and/or any combination of the components 202 and systems described herein, may be configured to support software needs for the office 102. To this end, the infrastructure unit 104 and/or the systems 106 may have and/or support software packages including, but not limited to, virus protection software, application suites, email software, graphics/multimedia software, customer relationship management software, operating systems software, database software, virtual private network software, internet conferencing software, and the like. Further, the infrastructure unit 104 and/or the systems 106 may support any suitable data communications programming and/or integration services including, but not limited to database development, application development, network integration requirements, data communications integration requirements, and the like.

The infrastructure unit 104 may further have the security system component 324 (or controlled access component) as one of the technology components 202. The security system component may be configured to couple to the security system 122 of the office 102 (as shown in FIG. 1). The security system component may monitor the security system, and send and receive data to and from a remote security, or emergency office (not shown). For example, the security system component may receive a signal indicating that a door or window has been opened, or that there is motion in the office outside of business hours. The security system component may then communicate this information to outside security personnel, such as a police office, a security company, an office employee and the like. Any suitable security component may be used in the infrastructure unit 104 including, but not limited to, electronic access control, intrusion detection, access control, access control global applications, access control systems and database management, access control systems infrastructure, access control remote devices, access control interfaces, access control identification management systems, security access detection, access control vehicle identification system, intrusion detection control, intrusion detection control, GUI, logic systems, intrusion detection systems infrastructure and/or controls, intrusion detection remote devices, sensors, and/ controls, intrusion detection interfaces, perimeter security systems, electronic surveillance, video surveillance, electronic personal protection systems, and the like. The communication between the security system 122 and the remote security office may be any of the communication links 112 described herein.

The infrastructure unit 104 may further have the audio component as one of the technology components 202. The audio component may couple to the audio system 126 (as shown in FIG. 1). The audio component may control any number of audio systems to be broadcast over the audio system 126. For example, the audio component may include, but is not limited to an intercom system, a music system, an ambient noise system, and/or a white noise system. Therefore, once the infrastructure unit 104 is installed at the office, the communication links between the audio system and the audio component may be established in order to broadcast to the audio system 126. The music system of the audio component may include a CD player, an MP3 player, a satellite radio system, a digital music player, and MP4 player, and the like.

The infrastructure unit 104 may further have the audio/visual component (television or video conferencing component) as one of the technology components 202. The audio/visual component may couple to any number of displays (not shown) located about the office 102. The displays may broadcast television programs, ambient images, and the like. The audio/visual component for example may be a cable TV system, a satellite TV system, an optical TV system, a video conferencing systems, and the like. The audio/visual component may include any typical features of a display system such as a digital recorder (DVR), a camera, a channel guide and the like. Once the infrastructure unit 104 with the visual component is installed at the office, the displays may be linked to the visual component using any of the communication links 112 described herein. Further, the visual component may couple directly to an outside visual source (such as a cable company source) or one of the other components 202 in the infrastructure unit 104.

The infrastructure unit 104 may further have the closed circuit television component as one of the technology components 202. The closed circuit television component may couple to the closed circuit television system 124. The closed circuit television system 124 may monitor the inside and/or outside of the office 102. The closed circuit television component may receive data from the closed circuit television system 124 and broadcast it to any of the personnel described herein.

The infrastructure unit 104 may further have the heating ventilation and air conditioning (HVAC) component as one of the technology components 202. The HVAC component may be any suitable instrumentation and/or controls for an HVAC system. The HVAC component may be a direct digital control system for an HVAC system, an electric and electronic control system for an HVAC system, a sequence of operations controller for an HVAC system, and the like.

The infrastructure unit 104 may further have the office equipment management component, or building management component as one of the technology components 202. The office building management component may control any of the building systems for example the mechanical systems, the lighting systems, the shade systems, the audio visual and/or multimedia systems, the security system, the gas system, the portable water system, the hot water use and system and the like.

The infrastructure unit 104 may further have the emergency alert component as one of the technology components 202. The emergency alert component may be a fire or emergency alert system. For example, the emergency alert component may receive data from any number of smoke detectors, gas detectors, employee danger signals (or alarms), electronic detection systems, alarm systems, fire detection systems, electronic monitoring and/or controls, and the like. The emergency alert component may then transmit analyze and/or transmit the information received to an emergency response team such as paramedics, the fire department, the police and the like.

The infrastructure unit 104 may further have the healthcare component as one of the technology components 202. The healthcare component may be any suitable system and/or device for monitoring and/or controlling healthcare needs at the office. For example, the healthcare component may be a patient monitoring component, a telemetry component, a telemedicine component, a healthcare imaging component, a nurse call component, a code blue component, and the like.

The infrastructure unit 104 may further have a power supply component 318. The power supply component 318 may be coupled to the office power, or any other power source and provide power for all of the technology components 202 and/or equipment of the infrastructure unit 104. The power supply component may have any number of power strips to supply power to the components 202 and/or equipment in the housing 200. Further, the power supply component may have a power protection systems to prevent damage to the components 202 from outages and power surges.

The infrastructure unit 104 may further have an uninterrupted power supply (UPS) component 320 as one of the technology components 202. The uninterrupted power supply may be a backup power supply that is independent of the power supply component 318. Therefore, in the event that power is lost to the power supply component 318, power may be maintained to the infrastructure unit 104 via the uninterrupted power supply component. The UPS component may be powered by a battery backup, a generator, solar panels and the like.

Further, the components 202 in the infrastructure unit 104 may be any suitable device, or system for controlling, monitoring running, observing and/or maintaining any of the systems associated with the office, including those systems described herein.

In addition to the technology components 202 for running the office infrastructure, the infrastructure unit 104 may have any number of support systems. The support systems may include, but is not limited to, the technical support unit 204, the controller 205 (as shown in FIG. 2), and the/or the cooling unit 206.

The technical support unit 204 as shown in FIG. 3 is a laptop computer. In the event that there is a problem with the infrastructure unit 104, a user may open the door of the housing 200 and access the technical support unit 204. Upon opening the technical support unit 204, the user may be immediately linked to a technician at the technical support facility 116. The technician may then ask questions of the user to trouble shoot the infrastructure system 104. Further, the technical support unit 204 may include a camera, or webcam, that the technician may ask the user to direct onto the infrastructure unit 104. The technician may then visually determine which technology components 202 in the infrastructure unit 104 are failing. The technician may then instruct the user on how to fix the problem, fix the problem remotely, and/or send a technician to the infrastructure unit to fix the problem. Although the technical support unit 204 is described as a laptop computer, it should be appreciated that the technical support unit 204 may be any suitable component for troubleshooting the infrastructure unit 104 such as a cell phone, a personnel digital assistant (PDA), a web book, a camera, and the like.

The cooling unit 206 as shown in FIG. 3 is one or more intake fans 320. The intake fans 302 may suck outside air into the infrastructure unit 104 in order to cool the technology components 202 in the infrastructure unit 104. The housing 200 may be equipped with any number of exhaust vents 322 for directing the airflow through the housing 200. For example, as shown, the intake fans 320 suck air into the housing 200 at the bottom of the housing 200. The exhaust vents 322 are shown as being positioned near the top of the housing 200. Therefore, in this arrangement, the exhaust vents 322 would force the air past the technology components 202 between the intake fans 302 and the exhaust vents. It should be appreciated that the intake fans 320 and the exhaust vents 322 may be located at any suitable location. Although, the cooling unit 206 is described as an intake fan 320, it should be appreciated that any suitable cooling system may be used depending on the technology components 202 used and the environment of the infrastructure unit 104. For example, the cooling unit 206 may be an air conditioning unit having the necessary BTU load for the infrastructure unit. The air conditioned infrastructure unit 104 may be particularly useful if the infrastructure unit 104 is to be used in outdoor, or un-air conditioned environments.

The infrastructure unit 104 may have all low voltage cabling infrastructure that terminates in the infrastructure unit 104. Further, the communication links 112 in the office 102 may only need to be routed to one predetermined location in the office. This makes the construction of the office and the cabling more efficient.

The infrastructure unit 104 and/or the infrastructure systems 106 may have any suitable cabling system and/or cabling structure to support the office 102. For example, the cabling system(s) and/or the infrastructure unit 104 may have communications backbone cabling including, but not limited to, communications copper backbone cabling, communications optical fiber backbone cabling, communications coaxial backbone cabling, communication services cabling. Further, the cabling system(s) and/or the infrastructure unit 104 may have communications horizontal cabling including, but not limited to, voice communications horizontal cabling, data communications horizontal cabling, audio-video communications horizontal cabling, patient monitoring and telemetry communications, nurse call and/or intercom communications horizontal cabling, intermediate frequency/radio frequency, antennas communications horizontal cabling, and the like. Further, the infrastructure unit 104 may have any number of infrastructure components 202 for cabling including, but not limited to, communications cabinets, racks, frames, enclosures, communications termination blocks, patch panels, and the like.

When setting up the office 102 and/or the residence, the office personnel 114 (as shown in FIG. 1) may log onto their computer, or call/text the infrastructure unit 104 provider. The office personnel 114 may then be asked a series of questions, or prompts, to determine what type of infrastructure systems 106 may be used in the office 102. The office personnel 114 may be any suitable person for setting up the office including, but not limited to, an office manager, an owner, a construction manager, a home owner, a builder, and the like. The questions may determine the infrastructure systems needed, the size and/or technology capacity of each of the technology components 202, the potential to include more technology components 202 in the future, and the like. Once the office personnel 114 has established the infrastructure system needs, the infrastructure unit provider may begin constructing the infrastructure unit 104. If this is a new construction project, the infrastructure unit provider may contact the construction manager in order to give the construction manager the dimensions of the infrastructure unit 104, MEP requirements and the communication links needed at the site of the infrastructure unit 104.

Once the infrastructure unit 104 is constructed per the office's 102 infrastructure needs, the completed infrastructure unit may be delivered to the office 102. The outside and internal communication links may then be connected to the infrastructure unit 104. With the communication links coupled to the infrastructure unit 104 and the power supply provided, the infrastructure unit 104 may run any number of the infrastructure systems 106 at the office 102. When the office 102 is open, the infrastructure unit 104 supports the infrastructure systems 106 at the office 102. In the event of a loss of power or other disaster, the UPS component 302 (as shown in FIG. 3) may provide power to the infrastructure unit 104 until power is restored. Further, if there is a disaster that puts the infrastructure unit 104 at risk, the entire infrastructure unit 104 may be unhooked and moved out of the office 102 until it is safe to return to the office 102. Further, in the event the office 102 is to move to a new location, the infrastructure unit may be unhooked and moved to the new office. Once at the new office the infrastructure unit 104 may be installed to operate the infrastructure systems at the new office.

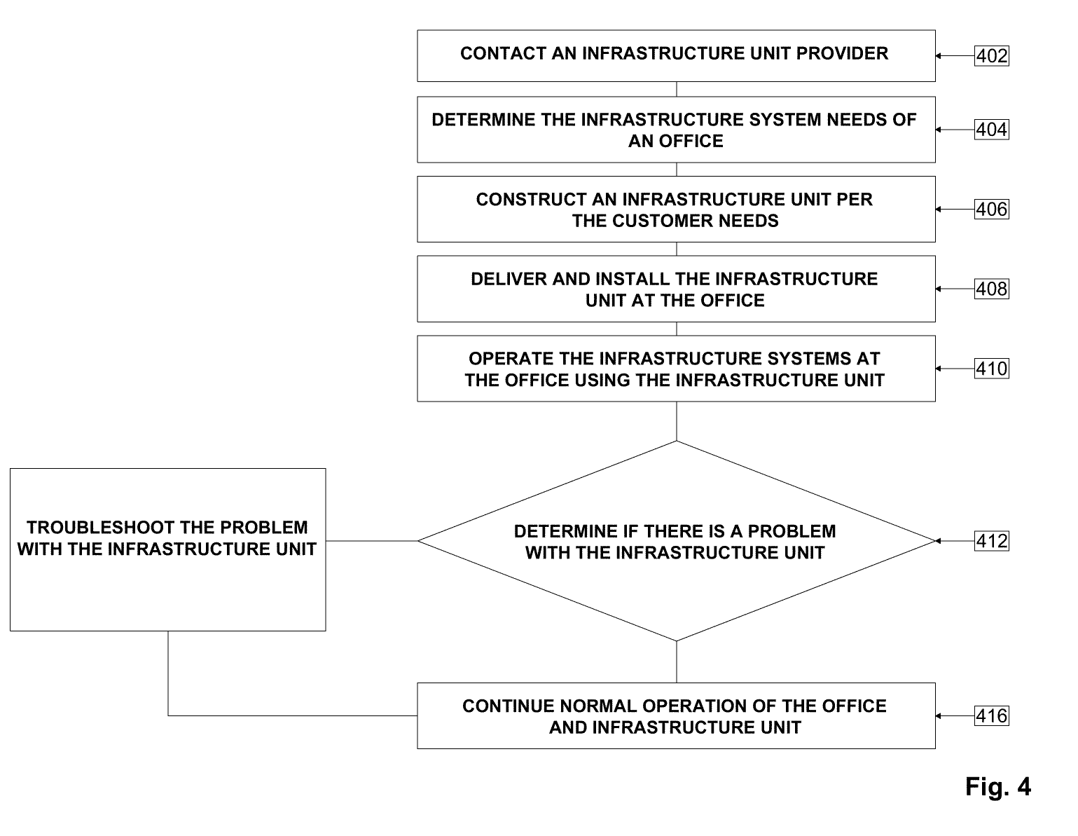

FIG. 4 depicts a flow diagram 400 illustrating the ordering and use of the consolidated infrastructure system 100, according to some embodiments of the invention. The flow begins at block 402, wherein an infrastructure unit provider is contacted by a customer. The infrastructure unit provider may be contacted by website, phone, text message, fax, mail and the like. The customer may be any of the office personnel and/or users described herein. The flow continues at block 404, wherein the infrastructure needs of the office 102 are determined. The infrastructure unit provider may ask a series of questions using any method to determine the infrastructure needs including, but not limited to having a questionnaire on a website, having drop down menus on a website, having a data base populated, receiving an order form, having an automated phone questionnaire and the like.

The flow continues at block 406, wherein the infrastructure unit 104 is constructed to suit customer's needs. The flow continues at block 408, wherein the infrastructure unit 104 is delivered to the office and installed. The infrastructure unit 104 may be delivered by any suitable method such as by truck, train, boat, plane, helicopter, and the like. Once at the office 102, the infrastructure unit 104 may simply be connected to each of the preinstalled infrastructure systems 106 (as shown in FIG. 1).

The flow continues at block 410, wherein the infrastructure unit 104 operates the infrastructure systems at the office. The flow may continue at block 412 where it may be determined that there is a problem with the infrastructure unit 104. If there is a problem with the infrastructure unit 104, the flow continues at block 414, wherein the technical support facility 116 (as shown in FIG. 1) troubleshoots the infrastructure unit 104. The technical support facility 116 may trouble shoot the infrastructure unit 104 using any suitable techniques including, but not limited to those described herein. For example, the user may activate the technical support unit 204 and send images of the infrastructure unit 104 to the technical support facility 116. The technical support facility 116 may then instruct the user how to fix the problem, fix the problem remotely and/or send a tech to fix the problem. If there is no problem with the infrastructure unit 104 or the problem is resolved, the flow continues at block 416 wherein the normal operation of the office 102 and the infrastructure unit 104 is continued.

The infrastructure unit 104 may lower the initial cost of setting up the office by utilizing cutting edge technologies such as centralized dimming, wireless device control, shared sensor technology, self powered devices, integrated IT networks, and the like. Further, the life cycle costs of the infrastructure unit 104 may be reduced due to building systems interacting more energy efficiently.

The infrastructure unit 104 is custom designed by the owner, or office personnel, to achieve the goals of the office. This front end design may provide several design and cost advantages during design, construction and engineering, such as a better coordinated drawing package for the construction project, better quality control and quality assurance, identifies design issues, minimizes errors and omissions, lower costs, better specification package, covers scope gaps between disciplines, cross-reference interrelated technologies correctly, more accurate cost estimating/GMP, more accurate bidding and scheduling, integrated technology, guides the design team through project phases with specific deliverables, clearly explains how all of the systems will function for all team members and manufactures, improves the understanding of technologies throughout the design phases, improves the end user experience with the various systems.

While the embodiments are described with reference to various implementations and exploitations, it will be understood that these embodiments are illustrative and that the scope of the inventive subject matter is not limited to them. Many variations, modifications, additions, and improvements are possible. For example, the techniques used herein may be applied across several types of offices and/or residences using multiple consolidated infrastructure systems.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An infrastructure unit for use at an office comprising:
a plurality of technology components wherein the plurality of technology components comprise:
a telephone component configured to communicate with one or more phone cords located at the building;
a server component for serving one or more client computers; and
a housing for containing the plurality of technology components and wherein the housing is movable within the office.

2. The infrastructure unit of claim 1, wherein the infrastructure unit is constructed offsite from the office and delivered to the office for installation.

3. The infrastructure unit of claim 1, wherein the plurality of technology components further comprises:
a data backup component;
a security system component;
a router system component;
an audio component;
a visual component;
a closed circuit television component;
an uninterrupted power supply component; and
a voice data system component.

4. The infrastructure unit of claim 1, further comprising a cooling unit.

5. The infrastructure unit of claim 4, wherein the infrastructure unit is for use in an outdoor environment and the cooling unit is an air conditioning unit.

6. The infrastructure unit of claim 1, further comprising a technical support unit located within the housing.

7. The infrastructure unit of claim 6, wherein the technical support unit further comprises a laptop computer.

8. The infrastructure unit of claim 1, further comprising one or more wheels coupled to the housing for moving the infrastructure unit.

9. The infrastructure unit of claim 1, wherein the housing is a blast proof housing.

10. A consolidated business system, comprising:
one or more infrastructure systems located at an office;
an infrastructure unit comprising:
one or more technology components wherein each of the plurality of technology components is configured to facilitate one of the one or more infrastructure systems; and
a housing for containing one or more technology components and wherein the housing is movable within the office.

11. The consolidated business system of claim 10, wherein the one of the one or more infrastructure systems is a telephone system and one of the one or more technology components is a telephone component.

12. The consolidated business system of claim 10, further comprising a technical support facility for providing technical support on the infrastructure unit.

13. The consolidated business system 10, further comprising a communication system for communicating with the infrastructure unit.

14. A method providing an infrastructure to an office, comprising:
determining one or more infrastructure needs of the office;
constructing an infrastructure unit per the determined infrastructure needs wherein the infrastructure unit comprises:
a plurality of technology components; and
a housing for containing the plurality of technology components and wherein the housing is movable within the office;
delivering the infrastructure unit to the office; and
installing the infrastructure unit to the office.

15. The method of claim 14, further comprising operating one or more infrastructure systems within the office with the infrastructure unit.

16. The method of claim 15, further comprising detecting a problem with the infrastructure unit.

17. The method of claim 16, further comprising contacting a technical support facility by accessing a technical support unit located with the housing.

18. The method of claim 17, further comprising providing an image of the infrastructure unit to the technical support facility using the technical support unit.

19. The method of claim 18, wherein the technical support unit is a laptop computer.

20. The method of claim 14, further comprising removing the infrastructure unit from the office to move to a new office.
